(19) United States
(12) Patent Application Publication
(10) Pub. No.: US 2022/0051189 A1
(43) Pub. Date: Feb. 17, 2022

(54) AUTOMATIC NEGOTIATION APPARATUS, AUTOMATIC NEGOTIATION METHOD, AND COMPUTER-READABLE RECORDING MEDIUM

(71) Applicant: NEC Corporation, Minato-ku, Tokyo (JP)

(72) Inventors: Yusuke KUBO, Tokyo (JP); Satoshi MORINAGA, Tokyo (JP); Shinji NAKADAI, Tokyo (JP)

(73) Assignee: NEC Corporation, Minato-ku, Tokyo (JP)

(21) Appl. No.: 17/435,790

(22) PCT Filed: Mar. 14, 2019
(86) PCT No.: PCT/JP2019/010578

§ 371 Date: Sep. 2, 2021

(51) Int. Cl. G06Q 10/08; G06Q 30/06

(52) U.S. Cl. CPC G06Q 10/08345; G06Q 30/0611

(57) ABSTRACT

An automatic negotiation apparatus is an apparatus for automatically negotiating with the other party. The automatic negotiation apparatus includes: a proposal candidate setting unit configured to set proposal candidates to be presented to the other party in a negotiation; a utility value calculation unit configured to calculate a utility value indicating a utility for when the candidate is accepted by the other party for each of the set candidates; a priority setting unit configured to select a candidate that meets set criteria using the utility value for each of the candidates, and further set a priority of each of the selected candidates; and a proposal unit configured to propose one of the selected candidates to the other party according to the priority.

### TECHNICAL FIELD

The present invention relates to an automatic negotiation apparatus and an automatic negotiation method for automating negotiations, and further relates to a computer-readable recording medium in which a program for realizing them is recorded.

### BACKGROUND ART

In recent years, a system for automatically performing negotiations using artificial intelligence (AI) has been developed. According to such a system, people are freed from troublesome work such as price negotiation, and thus it is conceivable that people can spend extra time on creative work, and that a better society will be realized.

An example of such a system is disclosed in Patent Document 1. The system disclosed in Patent Document 1 is a system having a function of handling financial negotiations between two entities. Specifically, when the system disclosed in Patent Document 1 makes a notification to two entities of the fact that they are participating in a negotiation, the system receives two (first and second) monetary proposals and a final proposal from one entity, and two (first and second) counter proposals from the other entity.

Subsequently, the system disclosed in Patent Document 1 compares the first monetary proposal from the one entity with the first counter proposal from the other entity, and if a difference between the two is within a set range, it notifies both entities of a successful agreement. On the contrary, if the difference between the two is not within the set range, the system disclosed in Patent Document 1 compares the second monetary proposal from the one entity with the second counter proposal from the other entity. Then, when a difference between the second monetary proposal and the second counter proposal is within the set range, the system disclosed in Patent Document 1 notifies both entities of a successful agreement.

Further, if the difference between the second monetary proposal and the second counter proposal is not within the set range, the system disclosed in Patent Document 1 compares the final proposal from the one entity and the first and second counter proposals from the other entity. Then, if a difference between the final proposal and any of the counter proposals is within the set range, the system disclosed in Patent Document 1 notifies both entities of a successful agreement. Further, if the difference between the final proposal and any of the counter proposals is not within the set range, the system disclosed in Patent Document 1 notifies each entity that no agreement has been reached.

### LIST OF RELATED ART DOCUMENTS

### Patent Document

Patent Document 1: Japanese Patent Laid-Open Publication No. 2012-64253

### SUMMARY OF INVENTION

### Problems to Be Solved By the Invention

As described above, according to the system disclosed in Patent Document 1, a financial negotiation can be automatically performed, but the negotiation can be performed only within a range of preset offers. Therefore, the system disclosed in Patent Document 1 has a problem in that it is not possible to negotiate according to an offer from the other party, and it is not possible to negotiate satisfactorily for both parties.

That is, in an actual negotiation, if there is no agreement between a monetary offer made by one and a counter offer made by the other, both parties make a reoffer depending on their own situation (for example, manufacturing cost, delivery date, or the like). However, the system disclosed in Patent Document 1 cannot make such a reoffer, and it is difficult for both parties to negotiate satisfactorily.

An example of an object of the present invention is to solve the above problems, and to provide an automatic negotiation apparatus and an automatic negotiation method, that can make a re-proposal according to the situation, when a negotiation with the other party is automatically performed, and a computer-readable recording medium.

### Means for Solving the Problems

In order to achieve the above object, an automatic negotiation apparatus in one aspect of the present invention includes:

a proposal candidate setting unit configured to set proposal candidates to be presented to the other party in a negotiation;

a utility value calculation unit configured to calculate a utility value indicating a utility for when the candidate is accepted by the other party for each of the set candidates;

a priority setting unit configured to select a candidate that meets set criteria using the utility value for each of the candidates, and further set a priority of each of the selected candidates based on the utility value; and

a proposal unit configured to propose one of the selected candidates to the other party according to the priority.

Further, in order to achieve the above object, an automatic negotiation method in one aspect of the present invention includes:

(a) setting proposal candidates to be presented to the other party in a negotiation;

(b) calculating a utility value indicating a utility for when the candidate is accepted by the other party, for each of the set candidates;

(c) selecting a candidate that meets set criteria using the utility value for each of the candidates, and setting a priority for each of the selected candidates based on the utility value; and

(d) proposing one of the selected candidates to the other party according to the priority.

Further, in order to achieve the above object, a computer-readable recording medium in one aspect of the present invention records a program including instructions for causing a computer to execute:

(a) a step of setting proposal candidates to be presented to the other party in a negotiation;

(b) a step of calculating a utility value indicating a utility for when the candidate is accepted by the other party, for each of the set candidates;

(c) a step of selecting a candidate that meets set criteria using the utility value for each of the candidates, and setting a priority for each of the selected candidates based on the utility value; and

(d) a step of proposing one of the selected candidates to the other party according to the priority.

### Advantageous Effects of the Invention

As described above, according to the present invention, it is possible to make a re-proposal according to the situation, when a negotiation with the other party is automatically performed.

### BRIEF DESCRIPTION OF THE DRAWINGS

FIG. 1 is a block diagram illustrating a configuration of an automatic negotiation apparatus according to an embodiment of the present invention.

FIG. 2 is a block diagram illustrating the automatic negotiation apparatus and its surrounding environment according to the embodiment of the present invention.

FIG. 3 is a flow chart illustrating an operation of an automatic negotiation apparatus 10 according to the embodiment of the present invention.

FIG. 4 is a block diagram illustrating an example of a computer that realizes the automatic negotiation apparatus according to the embodiment of the present invention.

### EXAMPLE EMBODIMENT

(Example Embodiment)

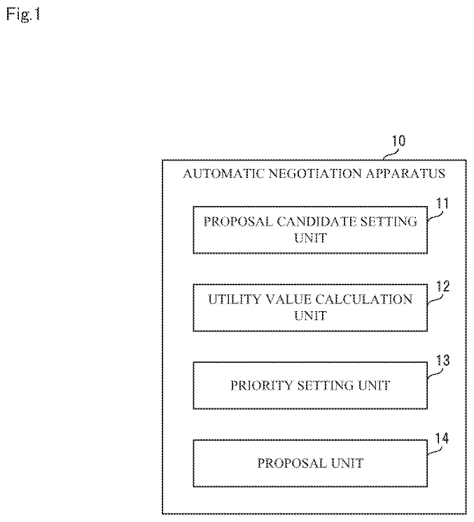

Hereinafter, an automatic negotiation apparatus, an automatic negotiation method, and a program according to an embodiment of the present invention will be described with reference to FIGS. 1 to 4.

[Apparatus Configuration]

First, a configuration of the automatic negotiation apparatus according to the present embodiment will be described with reference to FIG. 1. FIG. 1 is a block diagram illustrating a configuration of an automatic negotiation apparatus according to an embodiment of the present invention.

An automatic negotiation apparatus 10 in the present embodiment illustrated in FIG. 1 is an apparatus for automatically negotiating with another party. As illustrated in FIG. 1, the automatic negotiation apparatus 10 includes a proposal candidate setting unit 11, a utility value calculation unit 12, a priority setting unit 13, and a proposal unit 14.

The proposal candidate setting unit 11 sets proposal candidates to be presented to the other party in the negotiation. The utility value calculation unit 12 calculates a utility value indicating a utility for when the candidate is accepted by the other party, for each of the set candidates. The priority setting unit 13 selects a candidate that meets set criteria using the utility value for each of the candidates, and further sets a priority of each of the selected candidates based on the utility value. The proposal unit 14 proposes one of the selected candidates to the other party according to the priority.

The set criteria represents criteria for determining whether or not to select a candidate as a proposal candidate. In other words, the priority setting unit 13 selects proposal candidates using the utility value of each candidate, and uses the utility value to determine an order in which the selected proposal candidates are to be proposed to the other party. Then, the proposal unit 14 presents the proposal candidates to the other party according to the order determined by the priority setting unit 13.

The priority is, for example, an order advantageous to a negotiation source, or an order with which the negotiation can be easily concluded. When the utility value represents a benefit to the negotiation source, the order advantageous for the negotiation source is, for example, the order in which the benefit of the proposal candidate is large. Further, when the utility value represents a delivery date, the order advantageous to the negotiation source is, for example, the order in which the delivery date is close. When the utility value represents the benefit to the negotiation source, the order with which the negotiation can be easily concluded is, for example, the order in which the benefit is low. This is the case when the benefit of the negotiation source and a benefit of a negotiation destination conflict with each other. The priority is not limited to the above-mentioned examples.

As described above, in the present embodiment, the utility value is calculated for the proposal candidates set for the negotiation, and the priority of each of the proposal candidates is determined based on the utility value. That is, in the present embodiment, predetermined candidates are not proposed in an order in which they were set, but the candidates are proposed based on the utility value. Therefore, according to the present embodiment, when a negotiation with the other party is automatically performed, it is possible to make a re-proposal according to the situation.

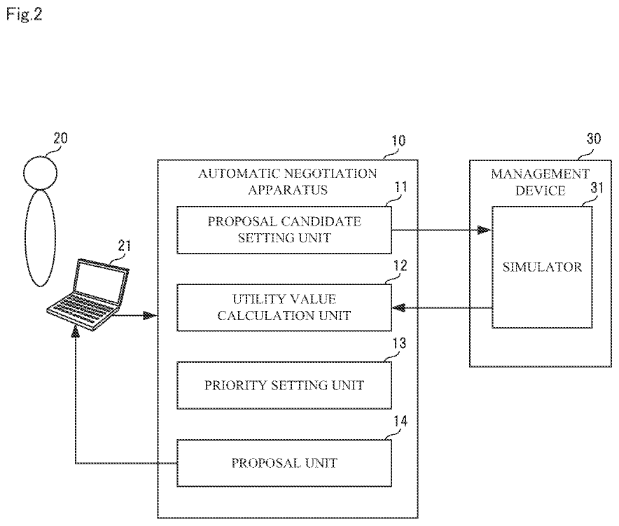

Subsequently, with reference to FIG. 2, the configuration and function of the automatic negotiation apparatus according to the present embodiment will be described more specifically. FIG. 2 is a block diagram illustrating the automatic negotiation apparatus and its surrounding environment according to the embodiment of the present invention.

As illustrated in FIG. 2, in the present embodiment, the automatic negotiation apparatus 10 is connected to a terminal device 21 of the other party 20 of a negotiation via a network or the like. Further, in the present embodiment, the automatic negotiation apparatus 10 is an apparatus for automatically negotiating a price between the negotiation source and the negotiation destination (the other party).

For example, the automatic negotiation apparatus 10 is used in a price negotiation between an assembly manufacturer that purchases parts and a supplier that supplies parts. In this case, as illustrated in FIG. 2, the automatic negotiation apparatus 10 is connected to a management device 30 that manages a supplier's factory. Further, the management device 30 includes a simulator 31. For example, when a price and a quantity are specified for a specific part, the simulator 31 performs a simulation using parameters indicating the factory situation and the like to predict the cost of manufacturing and the like and the delivery date.

In the present embodiment, the proposal candidate setting unit 11 sets a plurality of candidates including the price, quantity, and delivery date for a specific product. Specifically, assuming that a negotiation matter X is the price negotiation of the specific part, the proposal candidate setting unit 11 sets candidates x1 to xn (n: arbitrary natural number) having four parameters, namely the product name, price, quantity, and delivery date.

Further, in the present embodiment, the proposal candidate setting unit 11 sets the candidates by performing an operation on a reference value used for the negotiation with the other party 20. For example, it is assumed that x1 (product A, BB dollars, CC pieces, month/day/2019) is set as the reference value. In this case, the proposal candidate setting unit 11 changes a value of at least one parameter value of the price, the quantity, and the delivery date to set a new candidate.

Further, in the case of price and quantity, a parameter value is changed by adding or subtracting a set amount ($100, 1 piece, or the like) or by multiplying a set coefficient (for example, 1.5 or the like). For example, the parameter value is changed for each parameter. Further, by adding a certain value or subtracting a certain value to or from the value set for the parameter (for example, price or quantity), the parameter value (for example, price or quantity) is updated. Further, the parameter value may be updated by adding (or subtracting) a random number (or pseudo-random number) having a predetermined degree of dispersion (for example, 3%, 5%, 10%, or the like of the parameter value) to the parameter value. Alternatively, the parameter value may be updated by multiplying the parameter value by a value having a predetermined ratio (for example, “1.01” representing a 1% increase, “0.95” representing a 5% decrease, or the like). Further, in the case of the delivery date, the parameter value is changed by postponing or advancing the set date. Furthermore, the proposal candidate setting unit 11 can further include a penalty when the other party makes a late delivery, in each candidate.

In the present embodiment, the utility value calculation unit 12 calculates the utility value for each candidate, using the price, quantity, delivery date, and an expected cost (for example, manufacturing cost, selling cost, and the like) when the candidate is adopted, which are included in the candidate. Further, when the penalty is included in the parameters of the candidate, the utility value calculation unit 12 calculates the utility value by also using the penalty included in the candidate. Specifically, the utility value calculation unit 12 calculates the utility value for when the delivery date will be met and when the delivery date will not be met, according to processes shown in the following Equations 1 and 2.

(Utility value)=(Price)×(Quantity)−(Cost) (When delivery date is met) (Equation 1)

(Utility value)=(Price)×(Quantity)−(Cost)−(Penalty) (When delivery date is not met) (Equation 2)

Therefore, in the case of this example, the utility value represents the degree of an advantage that the manufacturer (oneself) can obtain (or may obtain) when the supplier (the other party) accepts the proposal from the manufacturer (oneself).

Further, the utility value calculation unit 12 can also calculate the utility value by using the delivery date predicted when the candidate is adopted. In this case, the utility value calculation unit 12 first compares the delivery date expected when the candidate is adopted with the delivery date of the product in the candidate. Then, the utility value calculation unit 12 calculates the utility value according to the process shown in the above Equation 1 when the former is not delayed with respect to the latter, that is, when the delivery of the product will meet the delivery date. On the other hand, the utility value calculation unit 12 calculates the utility value according to the process shown above when the former is delayed with respect to the latter, that is, when the delivery of the product will not meet the delivery date.

Further, the cost and the delivery date may be predicted by the simulator 31 described above, or may be manually predicted by an administrator or the like of the automatic negotiation apparatus 10. For example, the simulator 31 simulates an operation of each process of processing the product. Specifically, the simulator 31 calculates a period of time until the process is completed (or the cost required for the process) for each process according to an input amount of each process. Subsequently, the simulator 31 calculates a total value of the period of time (or the cost) calculated for each process. The simulator 31 predicts the delivery date (or the cost) by performing processing in this way.

In the present embodiment, the priority setting unit 13 compares the utility value and a threshold value for each candidate, and selects a candidate having a utility value not less than the threshold value as the candidate that meets the set criteria. Further, in the present embodiment, the priority setting unit 13 sets the priority for each selected candidate, for example, in descending order of the utility value.

Further, the priority setting unit 13 can also select the candidate that meets the set criteria by using a relationship between the delivery date for each candidate and the delivery date expected when the candidate is adopted. That is, the priority setting unit 13 can also select a candidate from the candidates in which the delivery date expected when the candidate is adopted is not delayed with respect to the delivery date of the product. Note that when the priority setting unit 13 does not select a candidate that meets the set criteria, the proposal unit 14 terminates the negotiation with the other party 20.

[Apparatus Operations]

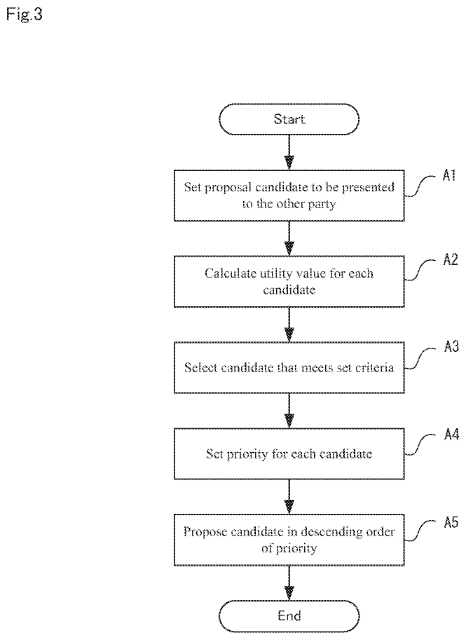

Next, an operation of the automatic negotiation apparatus 10 in the present embodiment will be described with reference to FIG. 3. FIG. 3 is a flow chart illustrating the operation of the automatic negotiation apparatus 10 according to the embodiment of the present invention.

In the following description, FIGS. 1 and 2 will be referred to as appropriate. Further, in the present embodiment, the automatic negotiation method is performed by operating the automatic negotiation apparatus 10. Therefore, description of the automatic negotiation method in the present embodiment will be replaced with the following description of the operation of the automatic negotiation apparatus 10.

As illustrated in FIG. 3, first, the proposal candidate setting unit 11 acquires the reference value to be used in the negotiation from the outside, and sets a plurality of proposal candidates to be presented to the other party 20 based on the acquired reference value (Step A1). In Step A1, the reference value is set, for example, by the administrator of the automatic negotiation apparatus 10.

Next, the utility value calculation unit 12 calculates the utility value indicating the utility for when the candidate is accepted by the other party, for each candidate set in Step A1 (Step A2). Specifically, the utility value calculation unit 12 inputs the parameters to the simulator 31 for each candidate to cause the simulator 31 to predict the cost, and calculates the utility value for each candidate according to the processes shown in the above Equations 1 and 2 using the predicted cost.

Subsequently, the priority setting unit 13 compares the utility value with the threshold value, and selects a candidate having a utility value not less than the threshold value as the candidate that meets the set criteria (Step A3). Subsequently, the priority setting unit 13 sets the priority for each selected candidate, for example, in descending order of the utility value (Step A4). Therefore, in the above-mentioned example, the priority setting unit 13 sets the priority of each candidate to the other party in the order advantageous for the negotiation source.

Subsequently, the proposal unit 14 proposes one of the selected candidates to the other party in descending order of priority (Step A5).

Specifically, in Step A5, the proposal unit 14 first transmits information regarding the candidate having the highest priority to the terminal device 21 of the other party 20. Then, upon receiving a notification indicating that the proposal has been accepted from the terminal device 21 of the other party 20, the proposal unit 14 notifies the administrator of the automatic negotiation apparatus 10 that the negotiation has been terminated.

On the other hand, when the proposal unit 14 receives a notification indicating that the proposal is not accepted from the terminal device 21 of the other party 20, the proposal unit 14 transmits the information regarding the candidate having the next highest priority to the terminal device 21 of the other party 20. The proposal unit 14 repeats the above-mentioned process until it receives the notification indicating that the proposal has been accepted from the terminal device 21 of the other party 20, or until all candidates have been proposed.

[Effects of Embodiment]

As described above, in the present embodiment, in the price negotiation of the product, the utility value is calculated for each proposal candidate in consideration of, for example, the cost of manufacturing the product and the delivery date, and multiple proposals can be made to the other party 20 based on the utility value. According to the present embodiment, when the negotiation with the other party is automatically performed, it is possible to make a re-proposal according to the situation.

### EXAMPLE 1

Subsequently, Examples 1 to 6 of the present embodiment will be described below.

In Example 1, the proposal candidate setting unit 11 first acquires x1 (product A, $100, 50 pieces, Mar. 30, 2018) as the reference value (product name, price, quantity, and delivery date). Then, since the higher the price, the higher the utility is to this side, the proposal candidate setting unit 11 sets x2 (product A, $200, 50 pieces, Mar. 30, 2018) and x3 (product A, $500, 50 pieces, Mar. 30, 2018) as the candidates, based on x1. Note that x1 is also one of the candidates.

Subsequently, the utility value calculation unit 12 calculates the utility value for each of the candidates x1, x2, and x3 according to the process shown in the above Equation 1. Here, it is assumed that the simulator 31 predicts $500 as the cost for when each candidate is adopted. In this case, the utility value calculation unit 12 calculates 4,500, 9,500, and 24,500 respectively as the utility values of the candidates x1, x2, and x3.

Next, it is assumed that the threshold value of the utility value is set to 4,000 as a criteria for concluding the negotiation. In this case, the priority setting unit 13 selects the candidates x1, x2, and x3, and sets the priority in the order of x3, x2, and x1 based on the respective utility values. Then, the proposal unit 14 proposes the candidates to the other party 20 in the order of the candidates x3, x2, and x1.

### EXAMPLE 2

In Example 2, the proposal candidate setting unit 11 first acquires x1 (product A, $1,000, 50 pieces, Mar. 30, 2018, $15,000) as the reference value (product name, price, quantity, delivery date, penalty). Then, the proposal candidate setting unit 11 sets, as the candidates, x2 (product A, $2000, 50 pieces, Mar. 30, 2018, $ 10,000), x3 (product A, $1,000, 75 pieces, Mar. 30, 2018, $10,000), and x4 (product A, $1,000, 50 pieces, Apr. 14, 2018, $11,000), based on x1.

Subsequently, the utility value calculation unit 12 calculates the utility value for each of the candidates x1, x2, x3, and x4 according to the processes shown in the above Equations 1 and 2. Here, it is assumed that the simulator 31 predicts $500 as the cost for when each candidate is adopted. In this case, the utility value calculation unit 12 calculates 49,500, 99,500, 74,500, and 49,500 respectively as the utility values of the candidates x1, x2, x3, and x4, according to the process shown in Equation 1 (when the product A can be delivered by the delivery date). Further, the utility value calculation unit 12 calculates 34,500, 89,500, 64,500, and 38,500 respectively as the utility values of the candidates x1, x2, x3, and x4, according to the process shown in Equation 2 (when the product A cannot be delivered by the delivery date).

Next, it is assumed that the threshold value of the utility value is set to 49,500 as the criteria for concluding the negotiation. In this case, the priority setting unit 13 selects the candidates x1, x2, x3, and x4 as a case where the product can be delivered by the delivery date, and selects the candidates x2 and x3 as a case where the product cannot be delivered by the delivery date.

Then, in Example 2, the priority setting unit 13 proposes only the case where the product can be delivered by the delivery date. Therefore, the priority setting unit 13 sets the priority in the order of x2, x3, x1, and x4 or in the order of x2, x3, x4, and x1, because the utility values of x1 and x4 are the same based on the utility value of the candidates when the product can be delivered by the delivery date. Then, the proposal unit 14 proposes the candidates to the other party 20 in the order of the candidates x2, x3, x1, and x4, or in the order of x2, x3, x4, and x1.

### EXAMPLE 3

Also in Example 3, the proposal candidate setting unit 11 first acquires x1 (product A, $1,000, 50 pieces, Mar. 30, 2018, $16,000) as the reference value (product name, price, quantity, delivery date, penalty) as in Example 2. However, in Example 3, the proposal candidate setting unit 11 sets, as the candidates, x2 (product A, $800, 50 pieces, Mar. 30, 2018, $12,000), x3 (product A, $1,000, 40 pieces, Mar. 30, 2018, $10,000), and x4 (product A, $1,000, 50 pieces, Mar. 16, 2018, $11,000), based on x1.

Subsequently, the utility value calculation unit 12 calculates the utility value for each of the candidates x1, x2, x3, and x4 according to the processes shown in the above Equations 1 and 2. Here, it is assumed that the simulator 31 predicts $500 as the cost for when each candidate is adopted. In this case, the utility value calculation unit 12 calculates 49,500, 39,500, 39,500, and 49,500 respectively as the utility values of the candidates x1, x2, x3, and x4, according to the process shown in Equation 1 (when the product A can be delivered by the delivery date). Further, the utility value calculation unit 12 calculates 33,500, 27,500, 29,500, and 38,500 respectively as the utility values of the candidates x1, x2, x3, and x4, according to the process shown in Equation 2 (when the product A cannot be delivered by the delivery date).

Next, it is assumed that the threshold value of the utility value is set to 49,500 as the criteria for concluding the negotiation. In this case, the priority setting unit 13 selects the candidates x1 and x4 as the case where the product can be delivered by the delivery date, but there is no candidate that can be selected as the case where the product cannot be delivered by the delivery date.

Therefore, in Example 3, the priority setting unit 13 sets the priority in the order of x1 and x4, or in the order of x4 and x1 because the utility values of x1 and x4 are the same. Then, the proposal unit 14 proposes the candidates to the other party 20 in the order of candidates x1 and x4, or in the order of x4 and x1.

### EXAMPLE 4

Also in Example 4, the proposal candidate setting unit 11 first acquires x1 (product A, $1,000, 50 pieces, Mar. 30, 2018, $12,000) as the reference value (product name, price, quantity, delivery date, penalty) as in Examples 2 and 3. Then, as in Example 3, the proposal candidate setting unit 11 sets, as the candidates, x2 (product A, $ 800, 50 pieces, Mar. 30, 2018, $14,000), x3 (product A, $1,000, 40 pieces, Mar. 30, 2018, $9,000), and x4 (product A, $1,000, 50 pieces, Mar. 16, 2018, $8,000), based on x1.

Subsequently, the utility value calculation unit 12 calculates the utility value for each of the candidates x1, x2, x3, and x4 according to the processes shown in the above Equations 1 and 2. Here, it is assumed that the simulator 31 predicts $500 as the cost for when each candidate is adopted. In this case, the utility value calculation unit 12 calculates 49,500, 39,500, 39,500, and 49,500 respectively as the utility values of the candidates x1, x2, x3, and x4 from Equation 1 (when the product A can be delivered by the delivery date). Further, the utility value calculation unit 12 calculates 37,500, 27,500, 25,500, and 41,500 respectively as the utility values of the candidates x1, x2, x3, and x4, according to the process shown in Equation 2 (when the product A cannot be delivered by the delivery date).

Next, it is assumed that the threshold value of the utility value is set to 59,500 as the criteria for concluding the negotiation. In this case, since there is no candidate having a utility value not less than the threshold value, the priority setting unit 13 notifies the proposal unit 14 that there is no candidate that can be selected. Then, since a candidate that meets the set criteria has not been selected by the priority setting unit 13, the proposal unit 14 transmits a notification to close the negotiation to the terminal device 21 of the other party 20 in order to terminate the negotiation with the other party 20.

### EXAMPLE 5

Also in Example 5, the proposal candidate setting unit 11 first acquires x1 (product A, $1,000, 50 pieces, Mar. 30, 2018, $10,000) as the reference value (product name, price, quantity, delivery date, penalty) as in Examples 2 to 4. Then, the proposal candidate setting unit 11 sets, as the candidates, x2 (product A, $800, 100 pieces, Apr. 14, 2018, $10,000), x3 (product A, $850, 50 pieces, Apr. 14, 2018, $11,000), x4 (product A, $1,200, 50 pieces, Mar. 16, 2018, $9,000), x5 (product A, $850, 50 pieces, Mar. 16, 2018, $10,000), and x6 (product A, $1,200, 70 pieces, Apr. 14, 2018, $8,000), based on x1.

Subsequently, the utility value calculation unit 12 calculates the utility value for each of the candidates x1, x2, x3, x4, x5, and x6 according to the processes shown in the above Equations 1 and 2. Here, it is assumed that the simulator 31 predicts $500 as the cost for when each candidate is adopted. In this case, the utility value calculation unit 12 calculates 49,500, 79,500, 42,000, 59,500, 42,000, and 83,500 respectively as the utility values of the candidates x1, x2, x3, x4, x5, and x6, according to the process shown in Equation 1 (when the product A can be delivered by the delivery date). Further, the utility value calculation unit 12 calculates 39,500, 69,500, 31,000, 50,500, 32,000 and 75,500 respectively as the utility values of the candidates x1, x2, x3, and x4, according to the process shown in Equation 2 (when the product A cannot be delivered by the delivery date).

Next, it is assumed that the threshold value of the utility value is set to 59,500 as the criteria for concluding the negotiation. In this case, the priority setting unit 13 selects the candidates x2, x4, and x6 as the case where the product can be delivered by the delivery date, and selects the candidates x2 and x6 as the case where the product cannot be delivered by the delivery date.

Then, in Example 5, the priority setting unit 13 proposes both a case where the product can be delivered by the delivery date and a case where the product cannot be delivered by the delivery date. Therefore, the priority setting unit 13 sets the priority in the order of x6, x2, and x4 as the case where the product can be delivered by the delivery date, and further sets the priority in the order of x6 and x2 as the case where the product cannot be delivered by the delivery date.

In Example 5, the proposal unit 14 proposes the candidates to the other party 20 in the order of the candidates x6, x2, and x4, or in the order of x6 and x2, according to the delivery date predicted by the simulator 31.

### EXAMPLE 6

Also in Example 6, the proposal candidate setting unit 11 first acquires x1 (product A, $1,000, 50 pieces, Mar. 30, 2018, $10,000) as the reference value (product name, price, quantity, delivery date, penalty) as in Examples 2 to 5. Then, the proposal candidate setting unit 11 sets, as the candidates, x2 (product A, $800, 100 pieces, Apr. 14, 2018, $10,000), x3 (product A, $850, 50 pieces, Apr. 14, 2018, $10,000), x4 (product A, $1,200, 50 pieces, Mar. 16, 2018, $10,000), and x5 (product A, $850, 50 pieces, Mar. 16, 2018, $10,000), based on x1.

Subsequently, the utility value calculation unit 12 calculates the utility value for each of the candidates x1, x2, x3, x4, and x5 according to the processes shown in the above Equations 1 and 2. Here, it is assumed that the simulator 31 predicts $500 as the cost for when each candidate is adopted. In this case, the utility value calculation unit 12 calculates 49,500, 79,500, 42,000, 59,500, and 42,000 respectively as the utility values of the candidates x1, x2, x3, x4, and x5, according to the process shown in Equation 1 (when the product A can be delivered by the delivery date). Further, the utility value calculation unit 12 calculates 39,500, 69,500, 32,000, 49,500, and 32,000 respectively as the utility values of the candidates x1, x2, x3, and x4, according to the process shown in Equation 2 (when the product A cannot be delivered by the delivery date).

Next, it is assumed that the threshold value of the utility value is set to 59,500 as the criteria for concluding the negotiation. In this case, the priority setting unit 13 selects the candidates x2 and x4 as the case where the product can be delivered by the delivery date, and selects the candidate x2 as the case where the product cannot be delivered by the delivery date.

Then, also in Example 6, the priority setting unit 13 proposes both the case where the product can be delivered by the delivery date and the case where the product cannot be delivered by the delivery date, as in Example 5. However, in Example 6, the priority setting unit 13 sets the priority in an order in which the utility value is closer to the threshold value. In this case, the priority setting unit 13 sets the priority in ascending order of the degree of advantage to oneself. Therefore, the priority setting unit 13 sets the priority in the order of x4 and x2 as the case where the product can be delivered by the delivery date. On the other hand, the priority setting unit 13 sets the priority only for x2 when the product cannot be delivered by the delivery date.

In Example 6, the proposal unit 14 proposes the candidates to the other party 20 in the order of the candidates x4 and x2, or only x2, according to the delivery date predicted by the simulator 31.

A process in the automatic negotiation apparatus 10 has been described assuming that the negotiation source is the manufacturer and the negotiation destination is the supplier, but the negotiation source may be the supplier and the negotiation source may be the manufacturer. The negotiating source and the negotiating destination are not limited to the above-mentioned examples.

[Program]

The program in the present embodiment may be any program for causing the computer to execute Steps A1 to A5 illustrated in FIG. 3. By installing this program in the computer and executing it, the automatic negotiation apparatus and the automatic negotiation method in the present embodiment can be realized. In this case, a processor of the computer functions as the proposal candidate setting unit 11, the utility value calculation unit 12, and the priority setting unit 13, and performs processing.

Further, the program in the present embodiment may be executed by a computer system constructed by a plurality of computers. In this case, for example, each computer may function as any of the proposal candidate setting unit 11, the utility value calculation unit 12, and the priority setting unit 13.

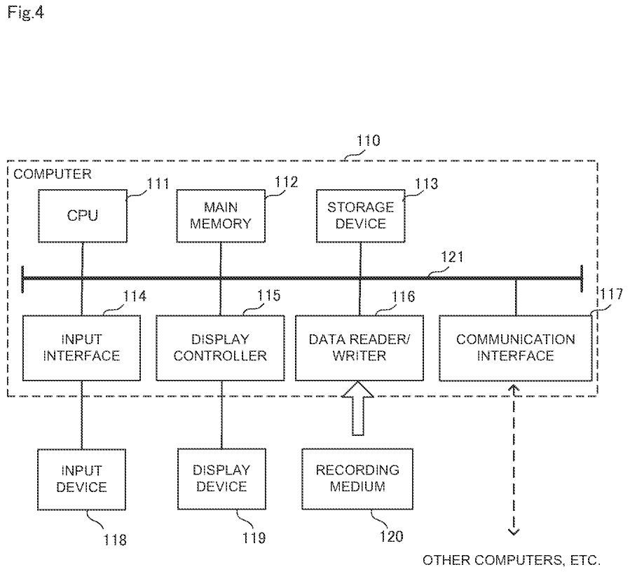

Here, the computer that realizes the automatic negotiation apparatus 10 by executing the program in the present embodiment will be described with reference to FIG. 4. FIG. 4 is a block diagram illustrating an example of the computer that realizes the automatic negotiation apparatus according to the embodiment of the present invention.

As illustrated in FIG. 4, a computer 110 includes a central processing unit (CPU) 111, a main memory 112, a storage device 113, an input interface 114, a display controller 115, a data reader/writer 116, and a communication interface 117. These parts are connected to each other via a bus 121 so as to be capable of data communication. Note that the computer 110 may include a graphics processing unit (GPU) or a field-programmable gate array (an FPGA) in addition to the CPU 111 or in place of the CPU 111.

The CPU 111 loads the program (code) in the present embodiment stored in the storage device 113 to the main memory 112 and executes the program in a predetermined order to perform various operations. The main memory 112 is typically a volatile storage device such as a dynamic random access memory (DRAM). Further, the program in the present embodiment is provided in a state of being stored in a computer-readable recording medium 120. The program in the present embodiment may be distributed on the Internet connected to the computer 110 via the communication interface 117.

Further, examples of the storage device 113 include a semiconductor storage device such as a flash memory in addition to a hard disk drive. The input interface 114 mediates data transmission between the CPU 111 and an input device 118 such as a keyboard and a mouse. The display controller 115 is connected to a display device 119 and controls display on the display device 119.

The data reader/writer 116 mediates the data transmission between the CPU 111 and the recording medium 120, reads the program from the recording medium 120, and writes a processing result in the computer 110 to the recording medium 120. The communication interface 117 mediates the data transmission between the CPU 111 and other computers.

Further, examples of the recording medium 120 include a general-purpose semiconductor storage device such as a compact flash (CF) (registered trademark) and a secure digital (SD), a magnetic recording medium such as a flexible disk, or an optical recording medium such as a compact disk read only memory (CD-ROM).

The automatic negotiation apparatus 10 in the present embodiment can also be realized by using hardware corresponding to each part instead of the computer in which the program is installed. Further, the automatic negotiation apparatus 10 may be partially realized by a program and the rest may be realized by hardware.

A part or all of the above-described example embodiment can be described by (Supplementary note 1) to (Supplementary note 21) described below, but it is not limited to the following descriptions.

(Supplementary Note 1)

An automatic negotiation apparatus including:

a proposal candidate setting unit configured to set proposal candidates to be presented to the other party in a negotiation;

a utility value calculation unit configured to calculate a utility value indicating a utility for when the candidate is accepted by the other party, for each of the set candidates;

a priority setting unit configured to select a candidate that meets set criteria using the utility value for each of the candidates, and further set a priority of each of the selected candidates based on the utility value; and

a proposal unit configured to propose one of the selected candidates to the other party according to the priority.

(Supplementary Note 2)

The automatic negotiation apparatus according to Supplementary note 1, in which

in order to automatically negotiate a price with the other party

the proposal candidate setting unit sets a plurality of the candidates including the price, quantity, and delivery date for a specific product, and

the utility value calculation unit calculates the utility value for each of the candidates by using the price, quantity, and delivery date included in the candidate and an expected cost for when the candidate is adopted.

(Supplementary Note 3)

The automatic negotiation apparatus according to Supplementary note 2, in which

the proposal candidate setting unit sets a plurality of the candidates further including a penalty in case of delay in delivery, and

the utility value calculation unit calculates the utility value for each of the candidates by further using the penalty included in the candidate.

(Supplementary Note 4)

The automatic negotiation apparatus according to Supplementary note 2 or 3, in which

the utility value calculation unit calculates the utility value for each of the candidates by using the cost for when the candidate is adopted, which is predicted by an external simulator.

(Supplementary Note 5)

The automatic negotiation apparatus according to any one of Supplementary notes 2 to 4, in which

the priority setting unit selects the candidate that meets the set criteria by further using a relationship between the delivery date for each of the candidates and the delivery date expected when the candidate is adopted, and sets the priority for each of the selected candidates.

(Supplementary Note 6)

The automatic negotiation apparatus according to any one of Supplementary notes 1 to 5, in which

the proposal candidate setting unit sets the candidate by performing an operation on a reference value used for the negotiation with the other party.

(Supplementary Note 7)

The automatic negotiation apparatus according to any one of Supplementary notes 1 to 6, in which

when the priority setting unit cannot select the candidate that meets the set criteria, the proposal unit terminates the negotiation with the other party.

(Supplementary Note 8)

An automatic negotiation method including:

(a) setting proposal candidates to be presented to the other party in a negotiation;

(b) calculating a utility value indicating a utility for when the candidate is accepted by the other party, for each of the set candidates;

(c) selecting a candidate that meets set criteria using the utility value for each of the candidates, and further setting a priority for each of the selected candidates; and

(d) proposing one of the selected candidates to the other party according to the priority.

(Supplementary Note 9)

The automatic negotiation method according to Supplementary note 8, in which

in order to automatically negotiate a price with the other party

in (a), a plurality of the candidates including the price, quantity, and delivery date for a specific product are set, and

in (b), the utility value for each of the candidates is calculated by using the price, quantity, and delivery date included in the candidate and an expected cost for when the candidate is adopted.

(Supplementary Note 10)

The automatic negotiation method according to Supplementary note 9, in which

in (a), the candidates further including a penalty in case of delay in delivery are set, and

in (b), the utility value is calculated for each of the candidates by further using the penalty included in the candidate.

(Supplementary Note 11)

The automatic negotiation method according to Supplementary note 9 or 10, in which

in (b), the utility value is calculated for each of the candidates by using the cost for when the candidate is adopted, which is predicted by an external simulator.

(Supplementary Note 12)

The automatic negotiation method according to any one of Supplementary notes 9 to 11, in which

in (c), the candidate that meets the set criteria is selected by further using a relationship between the delivery date for each of the candidates and the delivery date expected when the candidate is adopted, and the priority is set for each of the selected candidates.

(Supplementary Note 13)

The automatic negotiation method according to any one of Supplementary notes 8 to 12, in which

in (a), the candidate is set by performing an operation on a reference value used for the negotiation with the other party.

(Supplementary Note 14)

The automatic negotiation method according to any one of Supplementary notes 8 to 13, in which

in (c), when the candidate that meets the set criteria cannot be selected, the negotiation with the other party is terminated.

(Supplementary Note 15)

A computer-readable recording medium that records a program including instructions for causing a computer to execute:

(a) a step of setting proposal candidates to be presented to the other party in a negotiation;

(b) a step of calculating a utility value indicating a utility for when the candidate is accepted by the other party, for each of the set candidates;

(c) a step of selecting a candidate that meets set criteria using the utility value for each of the candidates, and setting a priority for each of the selected candidates based on the utility value; and

(d) a step of proposing one of the selected candidates to the other party according to the priority.

(Supplementary Note 16)

The computer-readable recording medium according to Supplementary note 15, in which

in order to automatically negotiate a price with the other party

in the (a) step, a plurality of the candidates including the price, quantity, and delivery date for a specific product are set, and

in the (b) step, the utility value for each of the candidates is calculated by using the price, quantity, and delivery date included in the candidate and an expected cost for when the candidate is adopted.

(Supplementary Note 17)

The computer-readable recording medium according to Supplementary note 16, in which

in the (a) step, the candidates further including a penalty in case of delay in delivery are set, and

in the (b) step, the utility value is calculated for each of the candidates by further using the penalty included in the candidate.

(Supplementary Note 18)

The computer-readable recording medium according to Supplementary note 16 or 17, in which

in the (b) step, the utility value is calculated for each of the candidates by using the cost for when the candidate is adopted, which is predicted by an external simulator.

(Supplementary Note 19)

The computer-readable recording medium according to any one of Supplementary notes 16 to 18, in which

in the (c) step, the candidate that meets the set criteria is selected by further using a relationship between the delivery date for each of the candidates and the delivery date expected when the candidate is adopted, and the priority is set for each of the selected candidates.

(Supplementary Note 20)

The computer-readable recording medium according to any one of Supplementary notes 15 to 19, in which

in the (a) step, the candidate is set by performing an operation on a reference value used for the negotiation with the other party.

(Supplementary Note 21)

The computer-readable recording medium according to any one of Supplementary notes 15 to 20, in which

the program further includes an instruction for causing the computer to execute

(e) a step of terminating the negotiation with the other party when the candidate that meets the set criteria cannot be selected, in the (c) step.

Although the present invention has been described above with reference to the example embodiment, the present invention is not limited to the above example embodiment. Various changes that can be understood by those skilled in the art can be made within the scope of the present invention in terms of the structure and details of the present invention.

### INDUSTRIAL APPLICABILITY

As described above, according to the present invention, when a negotiation with the other party is automatically performed, it is possible to make a re-proposal according to the situation. The present invention is useful, for example, in a system that automatically performs negotiations using AI.

When the automatic negotiation apparatus 10 concludes the negotiation with the other party, machines or the like used in a manufacturing factory or the like may be controlled according to a proposal agreed to by the other party. Generally, in the manufacturing factory, raw materials are processed into a product through a plurality of processes. In recent years, machines used in each process have been automated, and processing from raw materials to an intermediate product is performed under external control. For convenience of explanation, it is assumed that an intermediate product C is produced by processing a raw material A and a raw material B. It is assumed that the raw material A is manufactured in the manufacturing factory. It is assumed that the raw material B is manufactured through outsourcing. When a delivery date is included in the proposal that the automatic negotiation apparatus 10 has concluded with the other party, the automatic negotiation apparatus 10 controls the timing of feeding the raw material required for processing the raw material A into the machine processing the raw material A according to the delivery date. In this case, the machine that processes the raw material A receives the raw material and processes the raw material A according to the control. Through these processes, it is possible to improve efficiency of a manufacturing process in the manufacturing factory, such as eliminating the need to store the intermediate product.

### REFERENCE SIGNS LIST

10 Automatic negotiation apparatus

11 Proposal candidate setting unit

12 Utility value calculation unit

13 Priority setting unit

14 Proposal unit

20 Other party in negotiation

21 Terminal device

30 Management device

31 Simulator

110 Computer

111 CPU

112 Main memory

113 Storage device

114 Input interface

115 Display controller

116 Data reader/writer

117 Communication interface

118 Input device

119 Display device

120 Recording medium

121 Bus

What is claimed is:

1. An automatic negotiation apparatus comprising:
a proposal candidate setting unit configured to set proposal candidates to be presented to the other party in a negotiation;
a utility value calculation unit configured to calculate a utility value indicating a utility for when the candidate is accepted by the other party, for each of the set candidates;
a priority setting unit configured to select a candidate that meets set criteria using the utility value for each of the candidates, and further set a priority of each of the selected candidates based on the utility value; and
a proposal unit configured to propose one of the selected candidates to the other party according to the priority.

2. The automatic negotiation apparatus according to claim 1, wherein
in order to automatically negotiate a price with the other party
the proposal candidate setting unit sets a plurality of the candidates including the price, quantity, and delivery date for a specific product, and
the utility value calculation unit calculates the utility value for each of the candidates by using the price, quantity, and delivery date included in the candidate and an expected cost for when the candidate is adopted.

3. The automatic negotiation apparatus according to claim 2, wherein
the proposal candidate setting unit sets a plurality of the candidates further including a penalty in case of delay in delivery, and
the utility value calculation unit calculates the utility value for each of the candidates by further using the penalty included in the candidate.

4. The automatic negotiation apparatus according to claim 2, wherein
the utility value calculation unit calculates the utility value for each of the candidates by using the cost for when the candidate is adopted, which is predicted by an external simulator.

5. The automatic negotiation apparatus according to claim 2, wherein
the priority setting unit selects the candidate that meets the set criteria by further using a relationship between the delivery date for each of the candidates and the delivery date expected for when the candidate is adopted, and sets the priority for each of the selected candidates.

6. The automatic negotiation apparatus according to claim 1, wherein
the proposal candidate setting unit sets the candidate by performing an operation on a reference value used for the negotiation with the other party.

7. The automatic negotiation apparatus according to claim 1, wherein
when the priority setting unit does not select the candidate that meets the set criteria, the proposal unit terminates the negotiation with the other party.

8. An automatic negotiation method comprising:
setting proposal candidates to be presented to the other party in a negotiation;
calculating a utility value indicating a utility for when the candidate is accepted by the other party, for each of the set candidates;
selecting a candidate that meets set criteria using the utility value for each of the candidates, and further setting a priority for each of the selected candidates based on the utility; and
proposing one of the selected candidates to the other party according to the priority.

9. The automatic negotiation method according to claim 8, wherein
in order to automatically negotiate a price with the other party
in the setting, a plurality of the candidates including the price, quantity, and delivery date for a specific product are set, and
in the calculating, the utility value for each of the candidates is calculated by using the price, quantity, and delivery date included in the candidate and an expected cost for when the candidate is adopted.

10. The automatic negotiation method according to claim 9, wherein
in the setting, the candidates further including a penalty in case of delay in delivery are set, and
in the calculating, the utility value is calculated for each of the candidates by further using the penalty included in the candidate.

11. The automatic negotiation method according to claim 9, wherein
in the calculating, the utility value is calculated for each of the candidates by using the cost for when the candidate is adopted, which is predicted by an external simulator.

12. The automatic negotiation method according to claim 9, wherein
in the selecting, the candidate that meets the set criteria is selected by further using a relationship between the delivery date for each of the candidates and the delivery date expected for when the candidate is adopted, and the priority is set for each of the selected candidates.

13. The automatic negotiation method according to claim 8, wherein
in the setting, the candidate is set by performing an operation on a reference value used for the negotiation with the other party.

14. The automatic negotiation method according to claim 8, wherein
in the selecting, when the candidate that meets the set criteria does not be selected, the negotiation with the other party is terminated.

15. A non-transitory computer-readable recording medium that records a program including instructions for causing a computer to execute:
setting proposal candidates to be presented to the other party in a negotiation;
calculating a utility value indicating a utility for when the candidate is accepted by the other party, for each of the set candidates;
selecting a candidate that meets set criteria using the utility value for each of the candidates, and setting a priority for each of the selected candidates based on the utility value; and
proposing one of the selected candidates to the other party according to the priority.

16. The non-transitory computer-readable recording medium according to claim 15, wherein
in order to automatically negotiate a price with the other party
in the setting, a plurality of the candidates including the price, quantity, and delivery date for a specific product are set, and
in the calculating, the utility value for each of the candidates is calculated by using the price, quantity, and delivery date included in the candidate and an expected cost for when the candidate is adopted.

17. The non-transitory computer-readable recording medium according to claim 16, wherein
in the setting, the candidates further including a penalty in case of delay in delivery are set, and
in the calculating, the utility value is calculated for each of the candidates by further using the penalty included in the candidate.

18. The non-transitory computer-readable recording medium according to claim 16, wherein
in the calculating, the utility value is calculated for each of the candidates by using the cost for when the candidate is adopted, which is predicted by an external simulator.

19. The non-transitory computer-readable recording medium according to claim 16, wherein
in the selecting, the candidate that meets the set criteria is selected by further using a relationship between the delivery date for each of the candidates and the delivery date expected for when the candidate is adopted, and the priority is set for each of the selected candidates.

20. The non-transitory computer-readable recording medium according to claim 15, wherein
in the setting, the candidate is set by performing an operation on a reference value used for the negotiation with the other party.

21. (canceled)
